(19) United States
(12) Patent Application Publication
(10) Pub. No.: US 2014/0178753 A1
(43) Pub. Date: Jun. 26, 2014

(54) LITHIUM ION BATTERY AND ELECTRODE STRUCTURE THEREOF

(71) Applicant: INDUSTRIAL TECHNOLOGY RESEARCH INSTITUTE, Hsinchu (TW)

(72) Inventors: Wen-Bing Chu, Hsinchu City (TW); Ming-Yi Lu, Miaoli County (TW); Guan-Lin Lai, Hsinchu County (TW); Cheng-Jien Peng, Hsinchu County (TW); Tzu-Chi Chou, Taichung City (TW); Dar-Jen Liu, Taoyuan County (TW); Chang-Rung Yang, Hsinchu City (TW)

(73) Assignee: Industrial Technology Research Institute, Hsinchu (TW)

(21) Appl. No.: 13/875,288

(22) Filed: May 2, 2013

(30) Foreign Application Priority Data
Dec. 24, 2012 (TW) 101149627

(51) Int. Cl. H01M 4/13

(52) U.S. Cl. CPC H01M 4/13
USPC 429/211

(57) ABSTRACT

A lithium ion battery and an electrode structure thereof are provided. The electrode structure at least includes a current collecting substrate, an electrode active material layer on the current collecting substrate, and a complex thermo-sensitive coating layer sandwiched in between the current collecting substrate and the electrode active material layer. The complex thermo-sensitive coating layer at least contains two or more of PTC (positive temperature coefficient) materials so as to have adjustable stepped resistivity according to temperature rise.

### CROSS-REFERENCE TO RELATED APPLICATION

This application claims the priority benefit of Taiwan application no. 101149627, filed on Dec. 24, 2012. The entirety of the above-mentioned patent application is hereby incorporated by reference herein and made a part of this specification.

### TECHNICAL FIELD

The technical field relates to a lithium ion battery and an electrode structure thereof.

### BACKGROUND

A positive temperature coefficient (PTC) refers to materials or devices with very large PTCs, usually referred to as PTC thermistors, and are also referred to as resettable fuses. The PTC materials are divided into PPTC (polymer positive temperature coefficient) material and CPTC (ceramic positive temperature coefficient) material. The researched PPTC material is applied in the design of the exterior of the battery module, and the composition of PPTC material includes PE (polyethylene) polymer and conductive particles. Under normal conditions (low temperature), the conductive particles form a chained conductive channel in the polymer matrix material that in turn forms a conductive passage, where the device is in a state of low resistivity. When an over-current occurs in the circuit (e.g. a short circuit), the heat generated by the large current may melt the polymer crystals, interrupting the originally chained conductive channel. As a result, the device changes from low resistivity to high resistivity and blocks the circuit.

The design of the exterior PTC applied in lithium ion batteries may only prevent overcharging, and may not protect the battery with real time sensing when temperature of the interior of the battery rises, due to the design of the exterior PTC not being thermo-sensitive. Although the PTC in the electrode coating layer may improve the problems above, a design with only one step of blocking the electronic channel may only directly block the electronic channel when the battery temperature rises.

### SUMMARY

The disclosure provides an electrode structure for a lithium ion battery. The electrode structure includes a current collecting substrate, an electrode active material layer on the current collecting substrate, and a complex thermo-sensitive coating layer sandwiched in between the current collecting substrate and the electrode active material layer. The complex thermo-sensitive coating layer at least contains two or more of PTC (positive temperature coefficient) materials so as to have adjustable stepped resistivity according to temperature rise.

The disclosure also provides a lithium ion battery. The lithium ion battery at least includes an electrolyte solution and an electrode group, wherein the electrode group includes a cathode, an anode, and a separator between the cathode and the anode, and is characterized in that at least one of the cathode and the anode is the aforementioned electrode structure for the lithium ion battery.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a cross-sectional schematic diagram of an electrode structure for a lithium ion battery according to an exemplary embodiment of the disclosure.

FIG. 2 is a simulation curve graph of temperature against resistance ratio of the complex thermo-sensitive coating layer of FIG. 1.

FIG. 3 is a curve graph of temperature against resistivity of the PTC materials of experimental example 1 with different proportions.

FIG. 4 is a curve graph of temperature against resistance ratio of experimental example 2.

FIG. 5 is a curve graph of temperature against resistivity of experimental example 3.

FIG. 6 is a cross-sectional schematic diagram of a lithium ion battery according to another exemplary embodiment of the disclosure.

### DETAILED DESCRIPTION OF DISCLOSED EMBODIMENTS

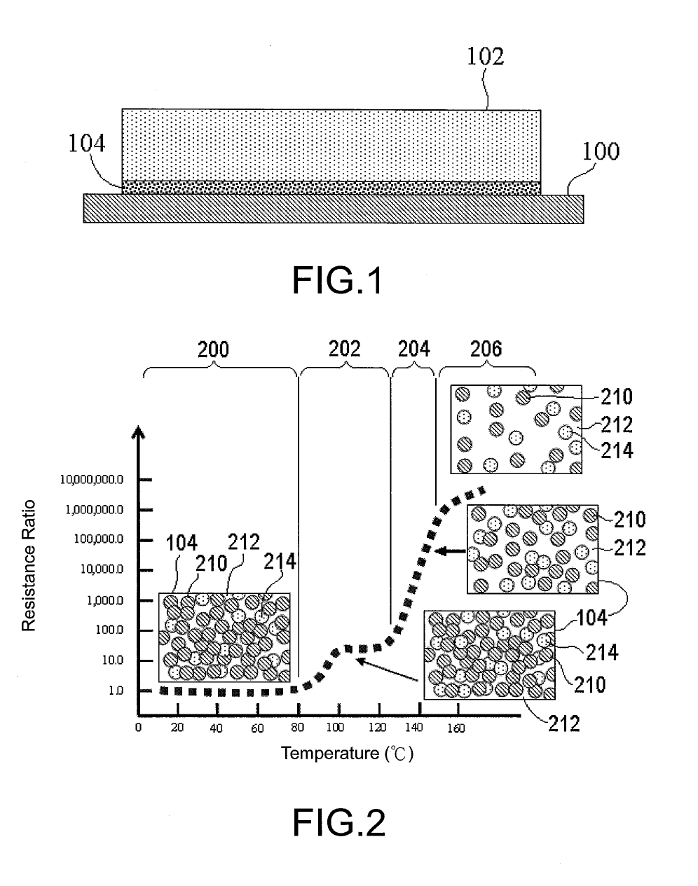

FIG. 1 is a cross-sectional schematic diagram of an electrode structure for a lithium ion battery according to an exemplary embodiment of the disclosure.

Referring to FIG. 1, the electrode structure for the lithium ion battery of the present embodiment includes a current collecting substrate 100, an electrode active material layer 102 on the current collecting substrate 100, and a complex thermo-sensitive coating layer 104. The aforementioned complex thermo-sensitive coating layer 104 is sandwiched in between the current collecting substrate 100 and the electrode active material layer 102 and has a conductive property. The complex thermo-sensitive coating layer 104 at least contains two or more of PTC (positive temperature coefficient) materials so as to have adjustable stepped resistivity according to temperature rise.

The “adjustable stepped resistivity according to temperature rise” in the disclosure refers to the stepwise resistivity change (at least two steps) with the increase of temperature, as shown in FIG. 2. FIG. 2 shows the change in the resistance ratio of the complex thermo-sensitive coating layer 104 as the temperature rises, wherein the simulation conditions are that the complex thermo-sensitive coating layer 104 contains one PPTC material and one CPTC material 210, and the PPTC material contains a polymer material 212 and conductive particles 214.

The polymer melting temperature of the PTC materials of the complex thermo-sensitive coating layer 104 is, for instance, between 70° C. and 160° C., preferably between 80° C. and 130° C. The ceramic Curie temperature of the PTC materials of the complex thermo-sensitive coating layer 104 is, for instance, between 60° C. and 120° C.

Continuing with FIG. 2, when the temperature is low (low temperature zone 200), the conductive particles 214 and the CPTC material 210 may form a chained conductive channel in the polymer material 212 that forms a low resistivity passage so the complex thermo-sensitive coating layer 104 is in a state of low resistivity. Since the CPTC material 210 in the complex thermo-sensitive coating layer 104 undergoes a phase transition near the Curie point, the resistivity increases slightly as the temperature rises and reaches the moderate-low temperature zone 202. Therefore, the flow of a large current may be controlled from the start and normal battery operation may be maintained. However, if the temperature further rises to the high temperature zone 204, the polymer material 212 will expand, thus disconnecting the chained conductive passage between the CPTC material 210 and the conductive particles 214, so that the resistivity of the complex thermo-sensitive coating layer 104 increases significantly. Therefore, when the temperature reaches the zone 206, the complex thermo-sensitive coating layer 104 becomes completely non-conductive, so that the path of the electrons is effectively cut off before the separator in the lithium ion battery melts, thus making the battery safer.

FIG. 2 is only used to explain the working principle of the present embodiment, and is not used to limit the scope of the disclosure. As long as the polymer melting temperatures (Tₘ) or the ceramic Curie temperatures (T_{c}) of the various PTC materials in the complex thermo-sensitive coating layer 104 of FIG. 1 are different, the complex thermo-sensitive coating layer 104 may be used in the disclosure. For instance, the PTC materials in the complex thermo-sensitive coating layer 104 may all be the CPTC material, and may also all be the PPTC material. Of course, the PTC materials in the complex thermo-sensitive coating layer 104 may also include both the PPTC material and the CPTC material as shown in FIG. 2. The working temperature range of the aforementioned PTC materials is, for instance, between 70° C. and 160° C., preferably between 80° C. and 130° C.

In the present embodiment, the aforementioned CPTC material may be doped-BaTiO₃, wherein the dopant elements of the doped-BaTiO₃ are selected from the group consisting of Cr, Pb, Ca, Sr, Ce, Mn, La, Y, Nb, Nd, Al, Cu, Si, Ta, Zr, Li, F, Mg, and lanthanide elements. Based on the total amount of the dopant elements, the content of Pb, Ca, Sr, or Si is 100 mol % or less, and the content of the other elements is 20 mol % or less. Moreover, when the PTC materials are all the CPTC material, polymer materials may be added to increase the adhesion. Moreover, when the PTC materials are all the CPTC material, conductive particles such as metal particles, metal oxides, or carbon black (termed as “first conductive particles” hereinafter) may also be added to improve the conductivity, wherein the carbon black is, for instance, conductive carbon (VGCF, Super P®, KS4®, KS6®, or ECP®), a nanoscale conductive carbon material, acetylene black or the like. The aforementioned first conductive particles usually account for 3 wt % to 5 wt % of the total amount of the complex thermo-sensitive coating layer 104, but the disclosure is not limited thereto. Moreover, the CPTC material and the first conductive particles account for, for instance, 20 wt % to 80 wt % of the total amount of the complex thermo-sensitive coating layer.

In the present embodiment, the polymer material in the PPTC material (provided the melting temperature of the polymer is between 70° C. and 160° C.) may be polyethylene (PE), polyvinylidene fluoride (PVDF), polypropylene (PP), polyvinyl acetate (PVA) or the like.

In the present embodiment, when the PTC materials are all the PPTC material, conductive particles in the aforementioned PPTC material (referred to as “second conductive particles” hereinafter) account for, for instance, 20 wt % to 80 wt % of the total amount of the complex thermo-sensitive coating layer. The aforementioned second conductive particles are, for instance, metal particles, metal oxides, or carbon black that improve the conductivity of the PPTC material. In particular, the carbon black is, for instance, conductive carbon (VGCF, Super P®, KS4®, KS6®, or ECP®), a nanoscale conductive carbon material, acetylene black or the like.

Moreover, if the PTC materials include both the PPTC material and the CPTC material, then the aforementioned CPTC material, first conductive particles, and second conductive particles account for, for instance, 20 wt % to 80 wt % of the total amount of the complex thermo-sensitive coating layer.

A plurality of experiments are listed below to demonstrate the efficacy of the disclosure.

### EXPERIMENTAL EXAMPLE 1

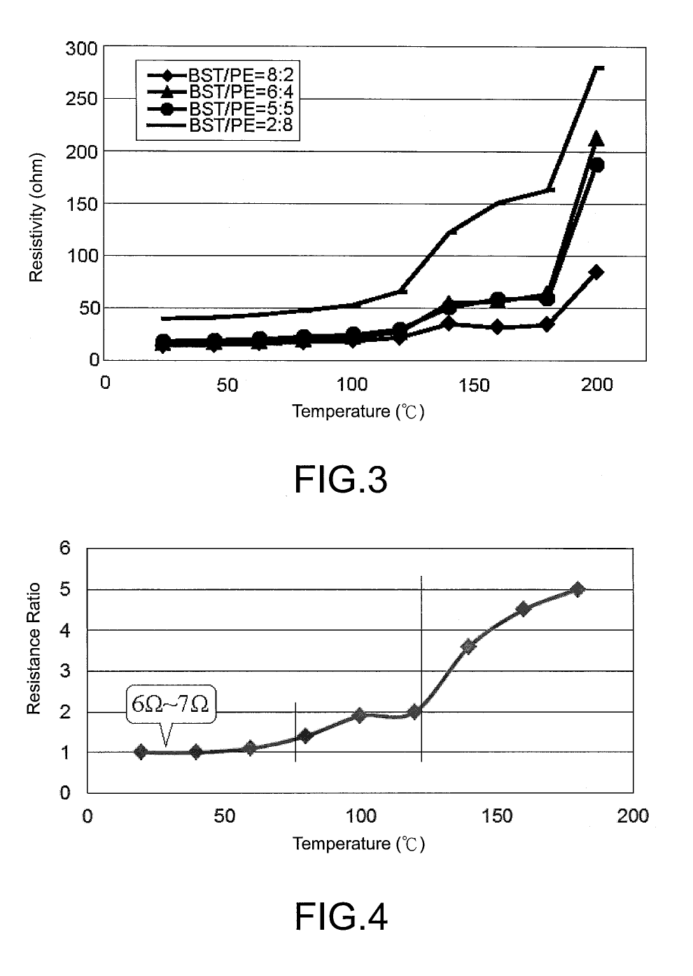

First, 0.4 mol % of Nb doped Ba_{0.9}Sr_{0.1}TiO₃ is mixed with polyethylene (PE) in a weight ratio of 8:2, 6:4, 5:5, or 2:8, and then 5 wt % of conductive particles (Super P®) are added. The mixture is evenly mixed and formed into a coating layer, and then the resistivity change of the coating layer according to temperature rise is measured. The result is shown in FIG. 3.

It is known from FIG. 3 that, the coating layer of experimental example 1 may achieve two steps of resistivity change. Although the ratio of the PPTC material to the CPTC material obtained in experimental example 1 is between about 2:8 to 8:2, when the material system is changed, the ratio may not be in the same range.

### EXPERIMENTAL EXAMPLE 2

First, 0.4 mol % of Nb doped Ba_{0.9}Sr_{0.1}TiO₃ is mixed with polyethylene (PE) in a weight ratio of 6:4, and then 5 wt % of conductive particles (Super P®) are added. The mixture is evenly mixed and formed into a coating layer, and then the resistivity change of the coating layer according to temperature rise is measured. The result is shown in FIG. 4. FIG. 4 may also achieve two steps of resistivity change.

### EXPERIMENTAL EXAMPLE 3

First, 0.4 mol % of Nb doped Ba_{0.9}Sr_{0.1}TiO₃ is mixed with polyethylene (PE) in a weight ratio of 2:1, and then 10 wt % of conductive particles (Super P®) are added. The mixture is evenly mixed and formed into a coating layer, and then the resistivity change of the coating layer according to temperature rise is measured. The result is shown in FIG. 5. FIG. 5 also shows two steps of resistivity change.

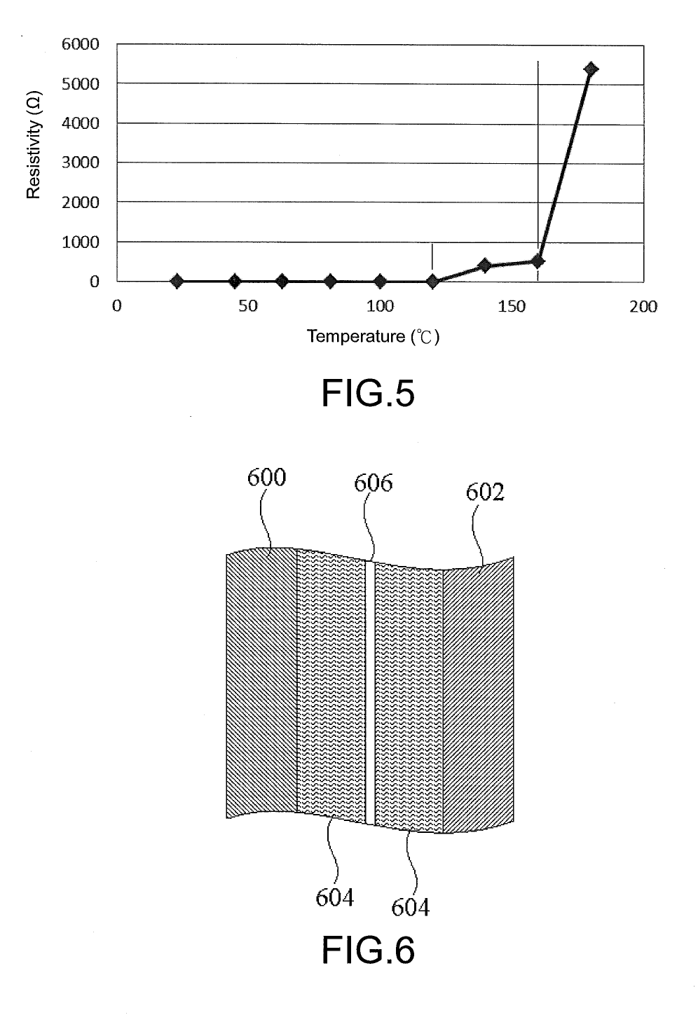

FIG. 6 is a cross-sectional schematic diagram of a lithium ion battery according to another exemplary embodiment of the disclosure.

In FIG. 6, the lithium ion battery at least includes an electrolyte solution 604 and an electrode group, wherein the electrode group includes a cathode 600, an anode 602, and a separator 606. The separator 606 is between the cathode 600 and the anode 602, and both the cathode 600 and the anode 602 may be the electrode structure for the lithium ion battery of FIG. 1. Alternatively, one of the cathode 600 and the anode 602 is the electrode structure for the lithium ion battery of FIG. 1. Since the electrode structure of FIG. 1 contains the complex thermo-sensitive coating layer, which may provide a safety design technique having adjustable stepped resistivity according to temperature rise, when the lithium ion battery is applied in the temperature which is higher than its danger range, the complex thermo-sensitive coating layer may implement a corresponding function according to the level of danger. In other words, the lithium ion battery still has the function of regulating the current flow in the beginning of the battery temperature rising, and thus the lithium ion battery maintains at a normal operational state. When the temperature continues to rise, before the separator 606 melts, the resistivity of the complex thermo-sensitive coating layer increases rapidly, completely blocking the current flow.

Based on the above, in the disclosure, the complex thermo-sensitive coating layer containing two or more of the PTCs is coated on the surface of the current collecting substrate so as to have adjustable stepped resistivity according to temperature rise. As a result, not only is the complex thermo-sensitive coating layer more sensitive in detecting the safety situation of the battery, but the complex thermo-sensitive coating layer is also able to control the current when over-temperature abnormality occurs locally in the interior of the battery. The probability of thermal runaway in the battery is thus significantly reduced.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An electrode structure for a lithium ion battery, comprising:
a current collecting substrate;
an electrode active material layer, located on the current collecting substrate; and
a complex thermo-sensitive coating layer, sandwiched in between the current collecting substrate and the electrode active material layer, wherein the complex thermo-sensitive coating layer at least comprises two or more of positive temperature coefficient (PTC) materials so as to have adjustable stepped resistivity according to temperature rise.

2. The electrode structure for the lithium ion battery of claim 1, wherein a working temperature range of the PTC materials is between 70° C. and 160° C.

3. The electrode structure for the lithium ion battery of claim 1, wherein the PTC materials comprise ceramic positive temperature coefficient (CPTC) materials.

4. The electrode structure for the lithium ion battery of claim 3, wherein a ceramic Curie temperature of the PTC materials is between 60° C. and 120° C.

5. The electrode structure for the lithium ion battery of claim 3, wherein the complex thermo-sensitive coating layer further comprises conductive particles.

6. The electrode structure for the lithium ion battery of claim 5, wherein the conductive particles comprise metal particles, metal oxides, or carbon black.

7. The electrode structure for the lithium ion battery of claim 6, wherein the carbon black comprises conductive carbon, a nanoscale conductive carbon material, or acetylene black.

8. The electrode structure for the lithium ion battery of claim 5, wherein the CPTC material and the conductive particles account for 20 wt % to 80 wt % of a total amount of the complex thermo-sensitive coating layer.

9. The electrode structure for the lithium ion battery of claim 3, wherein the complex thermo-sensitive coating layer further comprises a polymer material.

10. The electrode structure for the lithium ion battery of claim 3, wherein the CPTC material comprise doped-BaTiO₃.

11. The electrode structure for the lithium ion battery of claim 10, wherein dopant elements of the doped-BaTiO₃ are selected from the group consisting of Cr, Pb, Ca, Sr, Ce, Mn, La, Y, Nb, Nd, Al, Cu, Si, Ta, Zr, Li, F, Mg, and lanthanide elements.

12. The electrode structure for the lithium ion battery of claim 11, wherein based on a total amount of the dopant elements, a content of Pb, Ca, Sr, or Si is 100 mol % or less, and a content of other elements is 20 mol % or less.

13. The electrode structure for the lithium ion battery of claim 1, wherein the PTC materials comprise polymer positive temperature coefficient (PPTC) materials.

14. The electrode structure for the lithium ion battery of claim 13, wherein a polymer melting temperature of the PTC materials is between 70° C. and 160° C.

15. The electrode structure for the lithium ion battery of claim 13, wherein conductive particles in the PPTC material account for 20 wt % to 80 wt % of a total amount of the complex thermo-sensitive coating layer.

16. The electrode structure for the lithium ion battery of claim 15, wherein the conductive particles comprise metal particles, metal oxides, or carbon black.

17. The electrode structure for the lithium ion battery of claim 16, wherein the carbon black comprises conductive carbon, a nanoscale conductive carbon material, or acetylene black.

18. The electrode structure for the lithium ion battery of claim 1, wherein the PTC materials comprise a PPTC material and a CPTC material.

19. The electrode structure for the lithium ion battery of claim 18, wherein a ratio of the PPTC material to the CPTC material in the PTC materials is 2:8 to 8:2.

20. The electrode structure for the lithium ion battery of claim 18, wherein the complex thermo-sensitive coating layer further comprises first conductive particles.

21. The electrode structure for the lithium ion battery of claim 20, wherein the CPTC material, the first conductive particles, and second conductive particles in the PPTC material account for 20 wt % to 80 wt % of a total amount of the complex thermo-sensitive coating layer.

22. A lithium ion battery, at least comprising an electrolyte solution and an electrode group, wherein the electrode group comprises a cathode, an anode, and a separator between the cathode and the anode, and is characterized in that at least one of the cathode and the anode is the electrode structure for the lithium ion battery as claimed in claim 1.
